(19) United States
(12) Patent Application Publication
(10) Pub. No.: US 2023/0095463 A1
(43) Pub. Date: Mar. 30, 2023

(54) INTERACTIVE DIGITAL MEDIA CHALLENGE AND WAGERING SYSTEM AND METHOD FOR PLURALITY OF PLATFORMS

(71) Applicant: Wired Avenue, San Diego, CA (US)

(72) Inventors: Eduardo Vieira, San Diego, CA (US); Paul G. Campos, San Diego, CA (US); Mark E Haack, La Jolla, CA (US)

(21) Appl. No.: 17/876,440

(22) Filed: Jul. 28, 2022

Related U.S. Application Data
(63) Continuation-in-part of application No. 17/488,221, filed on Sep. 28, 2021.

(51) Int. Cl. G06Q 50/00; G06Q 50/34; G07F 17/32

(52) U.S. Cl. CPC G06Q 50/01; G06Q 50/34; G07F 17/3244; G07F 17/3288

(57) ABSTRACT

Embodiments of architecture, systems, and methods that enable Users of different computing platforms via various devices the ability to compete against and wager against each other via online challenges and other users to view such challenges, vote, and wager on such challenges.

### TECHNICAL FIELD

The present invention relates generally to the field of online challenges, and more particularly to digital media-based challenges between users.

### BACKGROUND INFORMATION

Users of different computing platforms via various devices may wish to compete and wager against each other via online challenges. Other users may want to view such challenges and vote and wager on such challenges, the present invention provides systems and methods for enabling such challenges across multiple platforms.

### BRIEF DESCRIPTION OF THE DRAWINGS

FIG. 1A is a block diagram of a user device for creating, competing in, voting, and wagering for challenge(s) in a system according to various embodiments.

FIG. 1B is a block diagram of a First User (challenger) employing a user interface for creating and competing in challenge(s) in a system according to various embodiments.

FIG. 1C is a block diagram of a Second User (opponent) employing a user interface for competing in challenge(s) in a system according to various embodiments.

FIGS. 1D-1G are illustrations of user interfaces for creating a challenge and wagering in a system according to various embodiments.

FIG. 2A is a block diagram of a Third User (challenge viewer) employing a user interface for viewing challenges between challenger(s) and opponent(s) in a system according to various embodiments.

FIG. 2B is a block diagram of a Third User (challenge viewer) employing a user interface to vote for a challenger or an opponent in a system according to various embodiments.

FIG. 2C is a user interface vote result interface/display after voting for a challenger or an opponent in a system according to various embodiments.

FIG. 2D is a block diagram of a Third User (challenge viewer) employing a user interface to vote for another user of multiple users (a challenger or an opponent) in a system according to various embodiments.

FIG. 2E is a user interface vote result interface/display after voting for another user in a system according to various embodiments.

FIG. 2F is an illustration of a user interface for viewing a challenge in a system according to various embodiments.

FIG. 2G is an illustration of a user interface for selecting to view the digital media content of one of the users (challenger/opponent) of a challenge in a system according to various embodiments.

FIG. 2H is an illustration of a user interface for voting for a selected one of the users (challenger/opponent) of a challenge in a system according to various embodiments.

FIG. 2I is an illustration of a user profile interface in a system according to various embodiments.

FIG. 2J is an illustration of a user's active challenge interface for a user profile and active challenges in a system according to various embodiments.

FIG. 3A is a diagram of the various challenge types.

FIG. 3B-J are diagrams of digital-media based challenge and wagering system data flows according to various embodiments.

FIGS. 4A and 4B are diagrams of architecture for implementing a digital-media based challenge and wagering system according to various embodiments.

FIG. 5 is a data processing system according to various embodiments.

### DETAILED DESCRIPTION

Users of different types of personal computing devices such as laptops, desktops, tablets, cellphones, and personal data devices regularly post digital media content on platforms, sometimes to challenge their friends or other platform users either directly or indirectly. For example, a User may post a digital image of themselves, a relative, pet, or possession to effectively challenge others to create related posts. They may post digital media including audio of a creation such as a performance or discussion for others to review or post related creations. They may also post digital video media showing activities they have completed, such as physical activity including an argument on a position or belief, singing a song, dancing, playing an instrument, or completing an athletically difficult activity, such as slam-dunking a basketball.

The present invention enables Users (challengers) to post digital media content that they want to use to challenge another particular user or random user(s) (opponent) having similar interests (posting related content in an embodiment). The present invention enables a User (challenger) to use their personal computing device to upload a number of different digital media types that may include content they have created, stored, or can access including digital images, digital audio, digital video, augmented reality-based (AR) media, and virtual reality (VR) based digital media. The challenger may also enter a wager or agree to an entry fee for their challenge. The wager and entry fee may be points/tokens/charitable donations associated with the present invention may have/represent monetary value, digital currency, physical assets or combinations thereof.

The present invention may alert the particular user or a random (opponent) user that another user (challenger) (or same user for self-challenge) has posted digital media content representing a challenge (with or without an associated wager) and to enable another user (opponent) to accept the challenge (and associated wager) and post their digital media content (response). The present invention may then enable 3^{rd} party users (challenge viewers) to view/listen to/perceive the digital media content of both users (challenger/opponent), in parallel or serially in an embodiment and then select the/vote for the User (challenger/opponent) that they believe has won the challenge or challenge and wager (via system points/token/charitable donation or monetary value) that their selection will win.

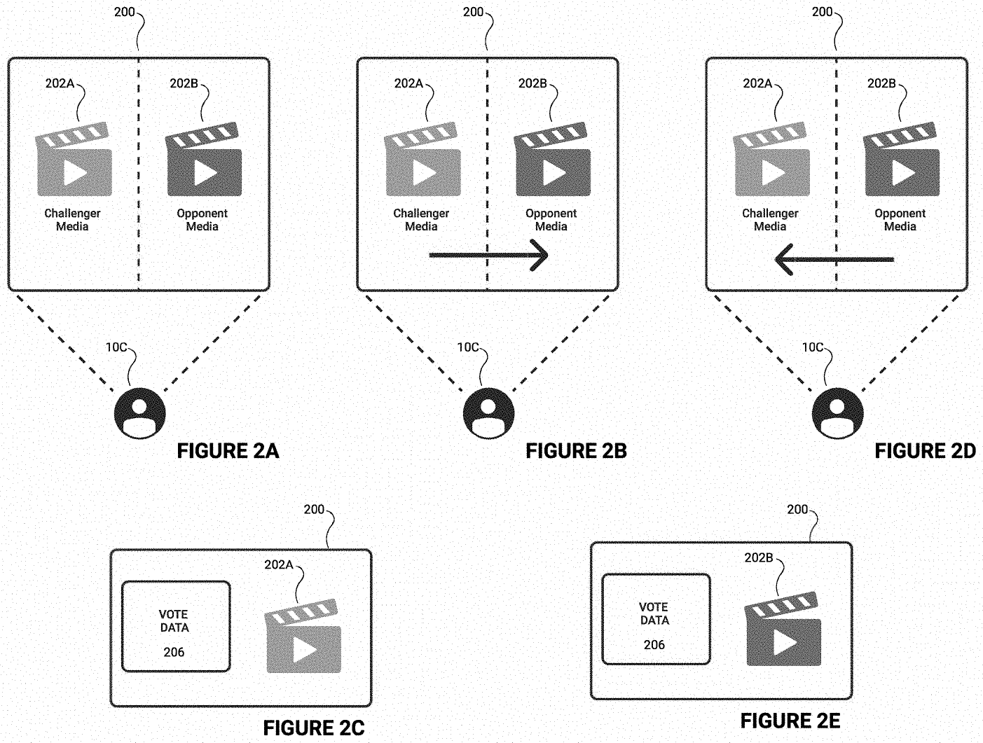

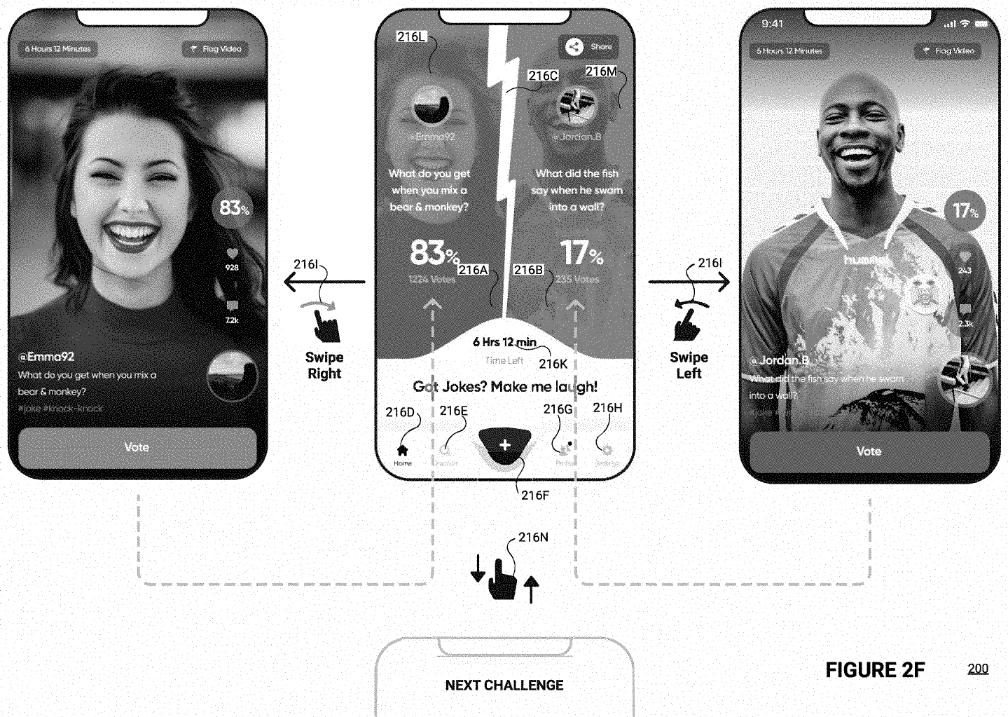

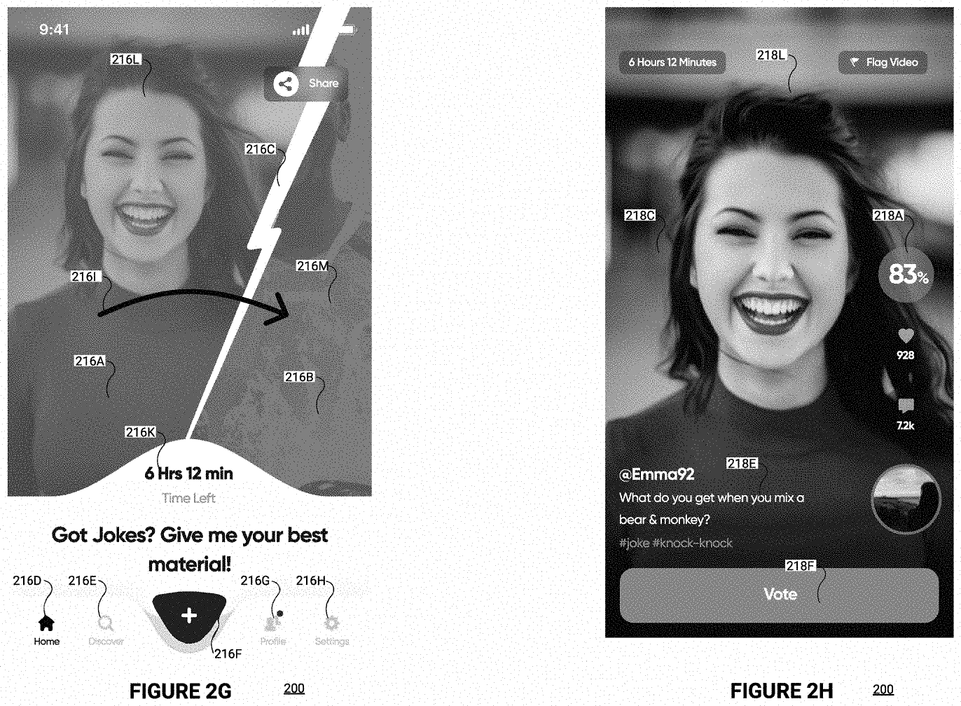

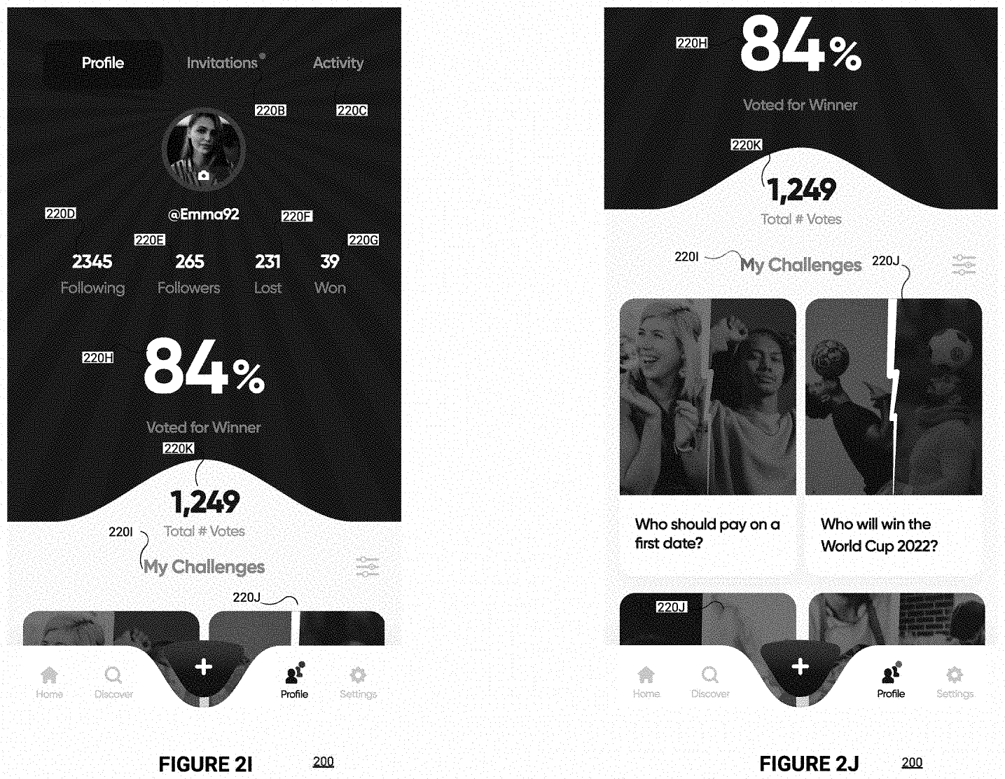

In an embodiment, the total votes collected/tabulated at the end of a predetermined period defined in architecture 180A, 180B may determine the User 10A-C (challenger/opponent) that won the challenge and decide any associated wagers. Where a challenger challenges themselves, the challenge viewer may select/vote for one of two or more digital media content(s) of the challenger. In an embodiment, a 3^{rd} party user (challenge viewer) may view a full challenge of a challenger/opponent via a first gesture including swiping, dragging, sliding in a first or second direction on or via an interface, as demonstrated in FIG. 2F.

In an embodiment, such a gesture may enable a challenge viewer to view a challenger's or an opponent's digital media content as a function of the digital media content and then have the option to vote for the viewed media content via a button or tile. For example, for VR based digital media content, a 3^{rd} party user (challenge viewer) may use a controller to gesture for content on a screen projection to view the full digital media content of challenger/opponent and then vote for a challenger/opponent via a button or tile or another indicator. In an embodiment, a challenger viewer may be able to view other challenges via a different, second gesture in another direction. In an embodiment, the first gesture may include a more left/right direction/orientation (216I) and the second gesture may include a more up/down direction/orientation (216N).

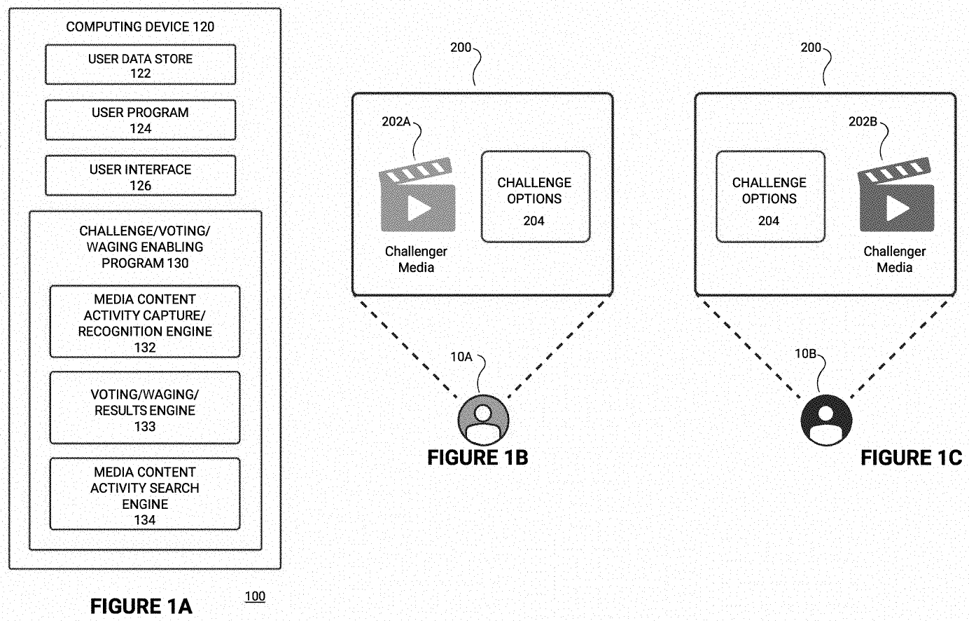

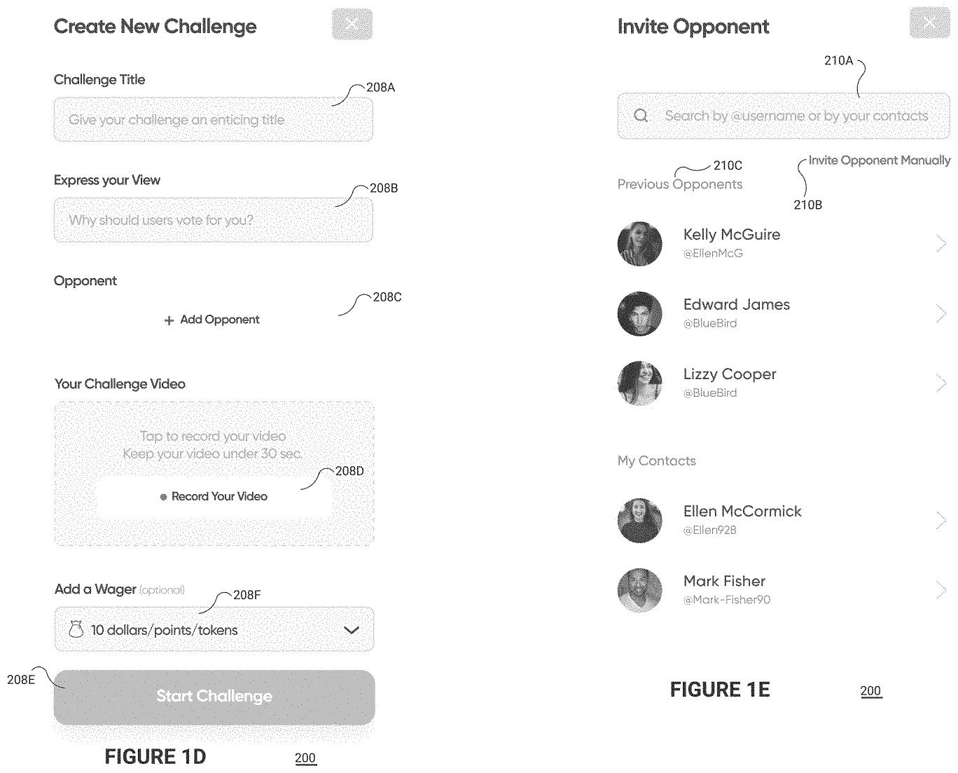

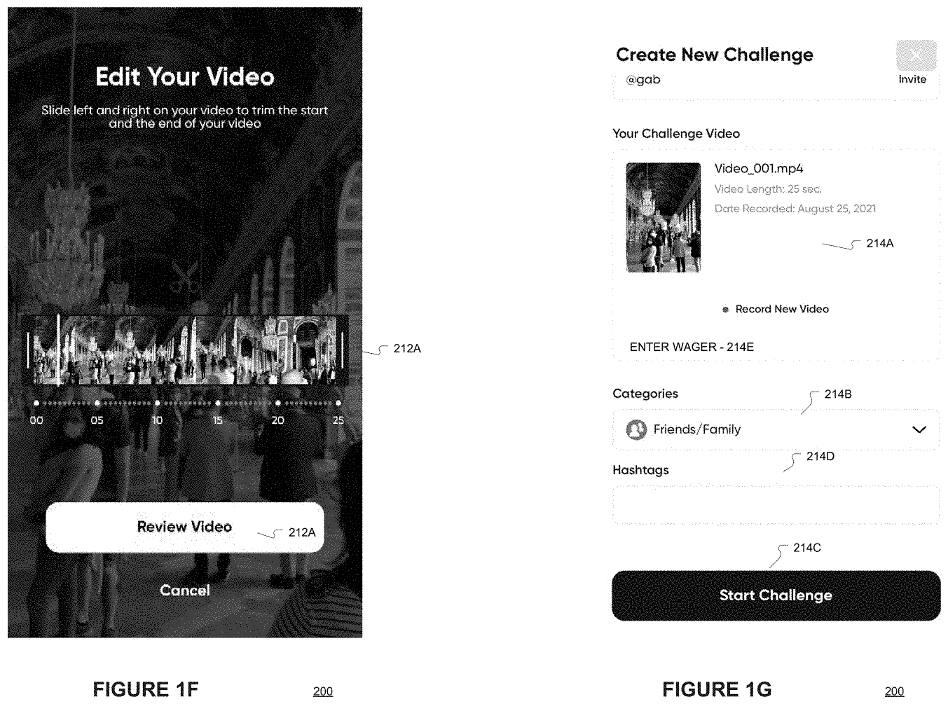

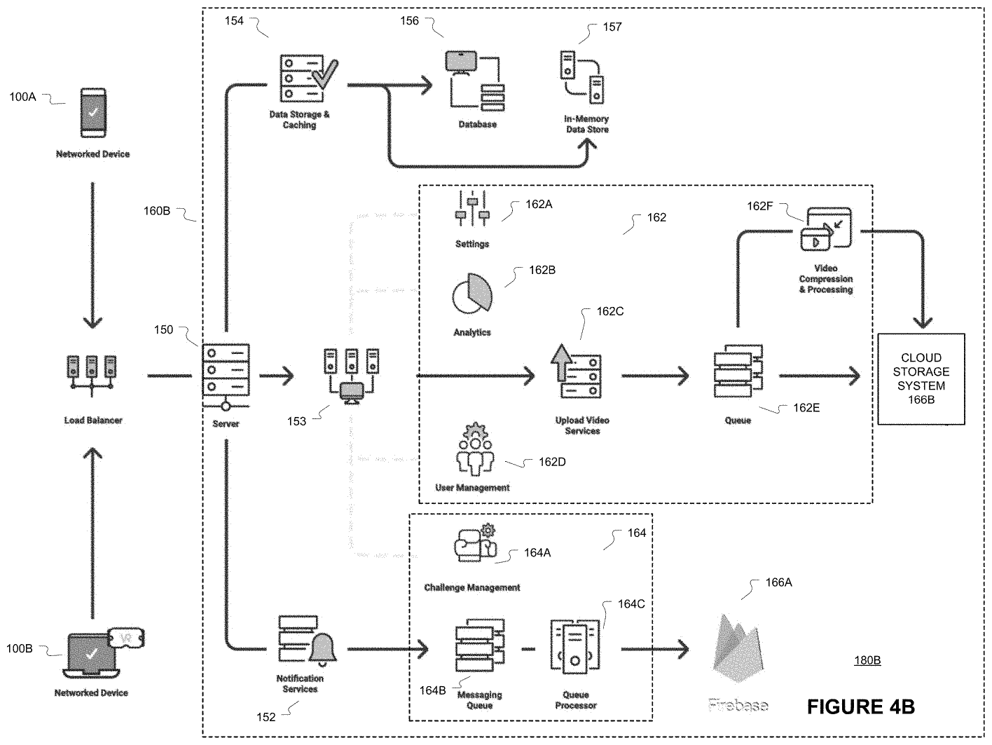

FIGS. 1A, 4A, and 4B is a functional block diagram illustrating computing environments 100, 180A, 180B, in accordance with an embodiment of the present invention. FIG. 1A provides only an illustration of one implementation and does not imply any limitations with regard to the environments in which different embodiments may be implemented. Many modifications to the depicted environment may be made by those skilled in the art without departing from the scope of the invention, as recited by the claims.

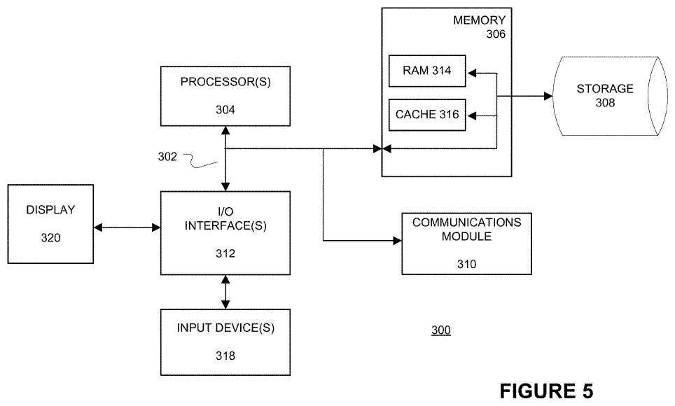

Computing environments 100, 180A, 180B includes computing device 120. In various embodiments of the present invention, computing device 120 can be a laptop computer, a tablet computer, a netbook computer, a personal computer (PC), a desktop computer, a personal digital assistant (PDA), a smartphone, or any programmable electronic device capable of executing computer readable program instructions. In a preferred embodiment, computing device 120 may be implemented with smart glasses. In general, computing device 120 is representative of any electronic device, or combination of electronic devices, that has a photo, audio, video, AR, VR, or other digital media capture device and is capable of executing machine-readable program instructions in accordance with embodiments of the present invention, as described in greater detail with regard to FIG. 5.

Computing device 120 may include a user interface (UI) 126, a user program 124, a user data store 122, and a challenge/voting/wagering enabling program 130. UI 126 may be, for example, a graphical user interface (GUI) or a web user interface (WUI) and may display text, documents, web browser windows, user options, application interfaces 200, and instructions for operation, and includes the information (such as graphic, text, and sound) a program presents to a user and the control sequences the user employs to control the program. UI 126 is capable of receiving data, user commands, user-generated digital media content and data input modifications from a user. UI 126 is also capable of communicating with user program 124 and digital media content activity capture/recognition engine 132.

The user program 124 receives information detailing preferences and interests of a user, creates user interest files, and stores the user interest files in data store 126 for future access, in accordance with embodiments of the present invention. The User (challenger/opponent/viewer) interests can be activities, other users (challenger/opponent/viewer), and past interactions to aid in creating future challenges for the User to generate, compete, or review/vote in an embodiment. The user interface 126 in combination with the challenge/voting/wagering enabling program 130 may provide the interfaces 200 shown in FIGS. 1B-1G and 2A-2J and enable a User to create, compete, review, wager, and vote on challenges. As shown in FIGS. 1B and 1C, a User (challenger/opponent) 10A, 10B may be able to view their proposed digital media content 202A, 202B (for challenge entry) and select one or more challenge options 204. The challenge options 204 may include a particular other User (opponent) 10A-C to be a contestant/opponent, a particular category to enter, timing, or other considerations.

FIGS. 1D-1G are illustrations of user interfaces for creating a challenge in a system according to various embodiments. In an embodiment, a User (challenger) 10A-C (10A for simplicity) may start a challenge request/creation process by selecting a challenge creation/generation option/button such as 216F in FIGS. 2F-G. Once a User 10A initiates the creation of a new challenge, the user interface 126 in combination with the challenge/voting/wagering enabling program 130 may provide the interface 200 shown in FIG. 1D. As shown in FIG. 1D, a User may be able to provide a title for their challenge 208A, provide a tagline or reason why other users (viewers) should vote for them 208B, select different opponent options 208C, upload or record digital media content including their activity that comprises the challenge 208D, add a wager 208F for their challenge, and initiate/start a challenge 208E. In an embodiment, a User 10A may be able to record digital media content live via their device 120 or select stored or accessible digital media content via their device 120 where the content may be stored on their device 120 or cloud storage but accessible by their device 120 or system 160A, 160B.

In an embodiment, a User 10A (challenger) may be able to select several opponent additional options 208C including challenging oneself, creating an open challenge, enabling the system 160A, 160B to select an opponent and specifying a particular opponent as shown in FIG. 1E and enter a wager for a challenge (FIG. 1G). In an embodiment, a User 10A may elect to challenge themself so other Users (viewers) may choose which User activity (represented by two, different digital media content uploads) they prefer, e.g., “which shoes should I wear with dress” with two digital media content uploads showing an image of a dress with a different pair of shoes.

A User 10A may also be able to request an open challenge. In such an embodiment, the system 160A, 160B may publish the challenge to a board where any other system 120 user 10A may be able to accept the challenge. The system 160A, 160B may publish the challenge to a particular group of Users 10A-C in an embodiment based on the category of the digital media content (as stated by the User—see FIG. 1G) or based on a digital analysis of the content by the system 160A, 160B. As shown in FIG. 1E, when a User 10A elects to specify a particular User 10B-C (opponent), the user interface 126 in combination with the challenge/voting/wagering enabling program 130 may provide the interface 200 shown in FIG. 1E. In an embodiment, a User 10A (challenger) may be able to reject or accept the proposed opponent (User 10B).

In an embodiment, a User 10A (challenger) may be able to create a variety of challenge types including a live challenge where the opponent (selected, random, or system 160A, 160B determined) may generate/provide digital media content at the same time or appointed time as the challenger. In an embodiment, a User 10A (challenger) may initiate a live challenge by creating a challenge and specifying a parameter indicating it's a live challenge along with other parameters. As noted, a user 10A (challenger) may specify an opponent via a direct invitation to a user 10B. The live challenge may also be open to the community of users of architecture 180A, 180B in an embodiment. Additionally, an opponent may be identified by a recommendation algorithm (AI) 55D, 55F including identifying evenly matched users 10A-C of architecture 180A, 180B based on a variety of parameters in an embodiment.

In an embodiment, when the live challenge is accepted by an opponent, the challenger and related users 10A-C may be notified and provided with a countdown. For example, systems 160A, 160B may notify other users 10A-C that may be interested in viewing the upcoming challenge, The users 10A-C may have viewed past live challenges or challenges involving either the challenger (User 10A) or opponent (User 10B). In an embodiment, such users 10C may be forwarded/provided a start time and may begin viewing the challenge at any time while it is live and accessible.

In an embodiment, the challenger(s) and opponent(s) may be able to engage in 2way or multiple-way communication via various media (audio/voice for example) during the entire challenge or specific periods. For example, a challenger and opponent may be granted sole ability to communicate, for a set period of time, while the other participant(s) remain muted.

Additionally, viewing users 10A-C may be able to communicate with other viewing users and the challenger(s) and opponent(s) during the entire challenge or specific periods in an embodiment. In an embodiment, a system 160A, 106B may provide a countdown along with instructions for challenger(s) and opponent(s) to get ready. In an embodiment, a challenger(s) or an opponent(s) may be granted first access to begin/complete their challenge. They may also be given the sole ability to communicate with other users during their access time interval. Then the process may repeat for other challenger(s) and opponent(s) until all challenger(s) and opponent(s) have completed their challenges in an embodiment.

In an embodiment, when all challenger(s) and opponent(s) have completed their challenges, they may be able to communicate with each other for a predetermined period of time such as during a time period when other Users (viewers) may be able to vote for challenger(s) and opponent(s). In an embodiment, the challenge may be live but the vote may be live or open for a predetermined time interval after the live challenge(s) are complete. In such an embodiment, the challenger(s)′ and opponent(s)′ submitted digital media content may be stored by the systems 160A, 160B and be available for viewing by Users 10A-C of architecture 180A, 180B.

As shown in FIG. 1E, a User 10A may enter a username associated with the challenge system 160A, 160B, or a User from their personal contacts. As also shown in FIG. 1E, a User 10A may be presented with a list or images of past opponents 210C or be able to enter/select an opponent manually 210B via various usernames/contacts associated with other platforms including short messaging service (SMS), Apple® messaging, email, or other communication platforms such as WhatsApp®, Signal, Instagram®, and others. Where the selected opponent is not registered with the system 160A, 160B, the system 160A, 160B may provide a link for the selected opponent to register with the system 160A, 160B and download software for their device 120.

As shown in FIG. 1F, the user interface 126 in combination with the challenge/voting/wagering enabling program 130 may enable a User 10A to modify their uploaded digital media content prior to starting a challenge via the interface 200. The interface 200 may display the uploaded digital media content over a time interval 212A and enable the User 10A to select a time segment of the uploaded digital media content and then review the resultant segment 212A. In an embodiment, the digital media content may include digital video of various formats such as MP4, HVEC, MPEG, TS, or others.

As shown in FIG. 1G, the user interface 126 in combination with the challenge/voting/wagering enabling program 130 may also enable a User 10A to select a category 214B and enter hashtags 214D associated with their activity represented by their uploaded digital media content 214A and then start the challenge 214C. In an embodiment, the categories may be selected from a pull-down list. A user may also be able to enter a wager 214E for their challenge, the participate in a challenge, to view a challenge, to vote on a challenge, or in addition to any of these activities. In an embodiment, environment 180A/180B shown in FIGS. 4A/4B may enable users to transfer/purchase or review points/tokens/charitable donations based on their activity in the environment 180A/180B including participating in a challenge, based on their results in such challenges, votes on challenges by others, and their success in voting for winner(s) of challenge(s) in part via a user computing device 120.

In an embodiment, the environments 100, 180A, 180B via the challenge enabling program 170 voting/wagering/results engine 173 of a server system 160A may enable Users (challengers and viewers thereof) to accept and enter various forms of wagers associated with challenges in the environments 100, 180A, 180B. As noted, the wager(s) may be via points that a User accumulates based on their activity in the environments 100, 180A, 180B. A User may also be able to purchase points via electronic payment(s) including via credit card, bitcoin, or other electronic payment/transfer platforms (including PayPal®, Venmo®, Zelle®, and other related platforms). A user may also be able to wager electronic funds directly in an embodiment. The server system 160A via programs 154 and 170 may be able to communicate with various electronic funds platforms to receive and transmit electronic funds.

For example, a User 10A, 10B may be able to convert funds or points in the environments 100, 180A, 180B into electronic funds, that are transmitted to other platforms including electronic funds platforms (including those noted and banking institutions). Similarly, the environments 100, 180A, 180B may be able to receive electronic funds from various platforms/institutions at the request of a User 10A, 10B via computer device 120. All funds/points/tokens/charitable donations and related activity may be stored in the vote-wager-challenge data store 156 in an embodiment.

User data store 122 may store user funds/points/token and related activity, interest files, digital-media content and preferences pertaining to the interests of a user. In this exemplary embodiment, user interest data store 122 resides locally on computing device 120. In other embodiments, user interest data store 122 can be hosted remotely and accessed via a network (e.g., a local area network (LAN), a wide area network (WAN) such as the Internet, or a combination of the two). User interest data store 122 can be implemented with any data store architecture known in the art, such as a relational database, an object-oriented database, and/or one or more tables.

In an embodiment, challenge/voting/wagering enabling program 130, in particular, the digital media content activity capture/recognition engine 132, may capture digital media content for use in challenges in an embodiment. The digital media content activity capture/recognition engine 132 may identify visible elements that match user interests stored in user interest data store 122 to automatically generate different digital media content segments to be used for challenges. The visible elements identified in the analyzed digital media content input, including, but not limited to, faces, objects, audio, locations, and combinations thereof. Challenge/voting/wagering enabling program 130, in conjunction with user interface 122, may enable the user to select one or more digital media content segments for use in a challenge.

In an embodiment, challenge/voting/wagering enabling program 130 in conjunction with the digital media content activity search engine 134, may search digital media content generated by various Users 10A-B and categorize the related activity. The digital media content activity search engine 134 may also identify visible elements that match or correlate to different categories or based on a search request for challenge(s) by a User 10A-B. The visible elements identified in the analyzed digital media content input, including, but not limited to, faces, objects, audio locations, and combinations thereof.

In this exemplary embodiment, the digital media content activity capture/recognition engine 132 and the digital media content activity search engine 134 may employ recognition software to analyze image and video input and output one or more identified visible elements. Digital media content activity capture/recognition engine 132 and the digital media content activity search engine 134 may be implemented with any suitable artificial intelligence (AI), optical character recognition (OCR), and geometry processing technology known in the art. For example, digital media content activity capture/recognition engine 132 and the digital media content activity search engine 134 may utilize AI, OCR, along with point cloud processing algorithms available in the Point Cloud Library (PCL), for analyzing image and video input and identifying visible elements therein. Although depicted as separate components, digital media content activity capture/recognition engine 130, the digital media content activity capture/recognition engine 132, and the digital media content activity search engine 134 may be partially or fully integrated with UI 122.

In an embodiment, the digital media content activity capture/recognition engine 132 may also encode captured digital media content using various encoding formats including audio, image, video, AR, and VR formats. The digital media content activity capture/recognition engine 132 may also include decoders to decode various formats including audio, image, video, AR, and VR formats so the digital media content may be analyzed to identify segments that may interest the User where the digital media content is provided by another User looking for a challenge. The engines 132 and 134 may also direct a User to view challenges occurring/that occurred between other users that may be of interest to the User (based upon their interests) so the User may view the content and vote for one of the two Users that generated the content.

The vote/wagering/results engine 133 in conjunction with the challenge/voting/wagering enabling program 130 may enable a User to view challenges between other Users based on a notice from system 160A, 160B or analysis from the engines 132/134 as shown in FIG. 2A. As shown in FIG. 2A, a non-competing User 10C may view the digital media content 202A, 202B for two Users, the content representing their challenge activity.

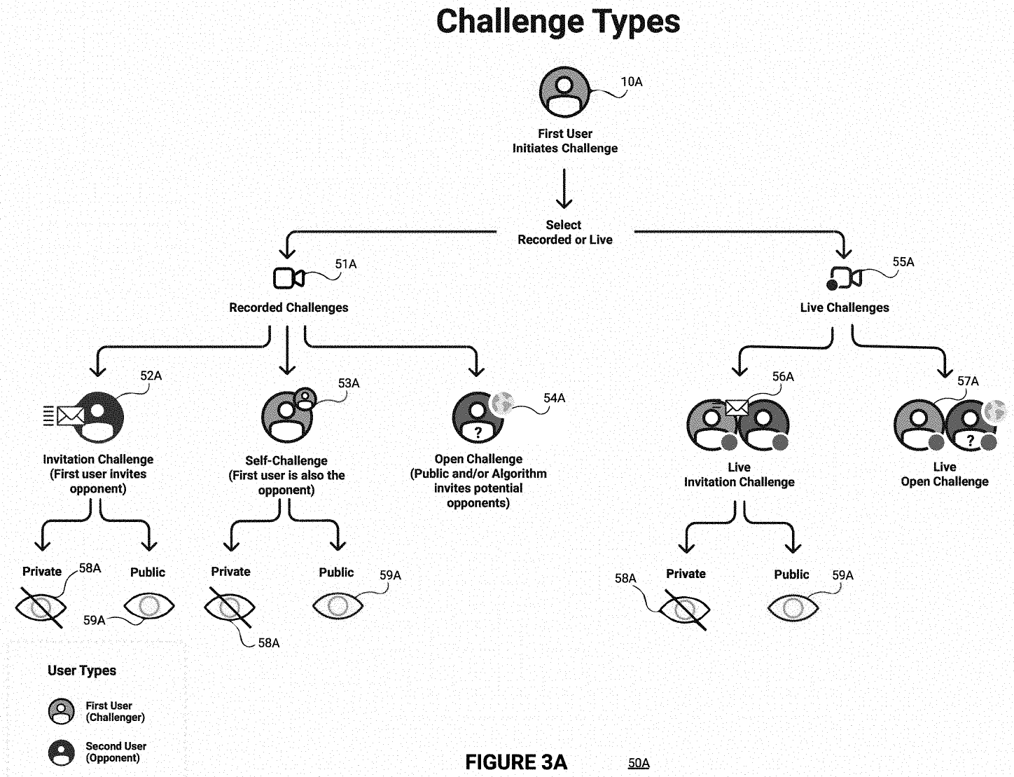

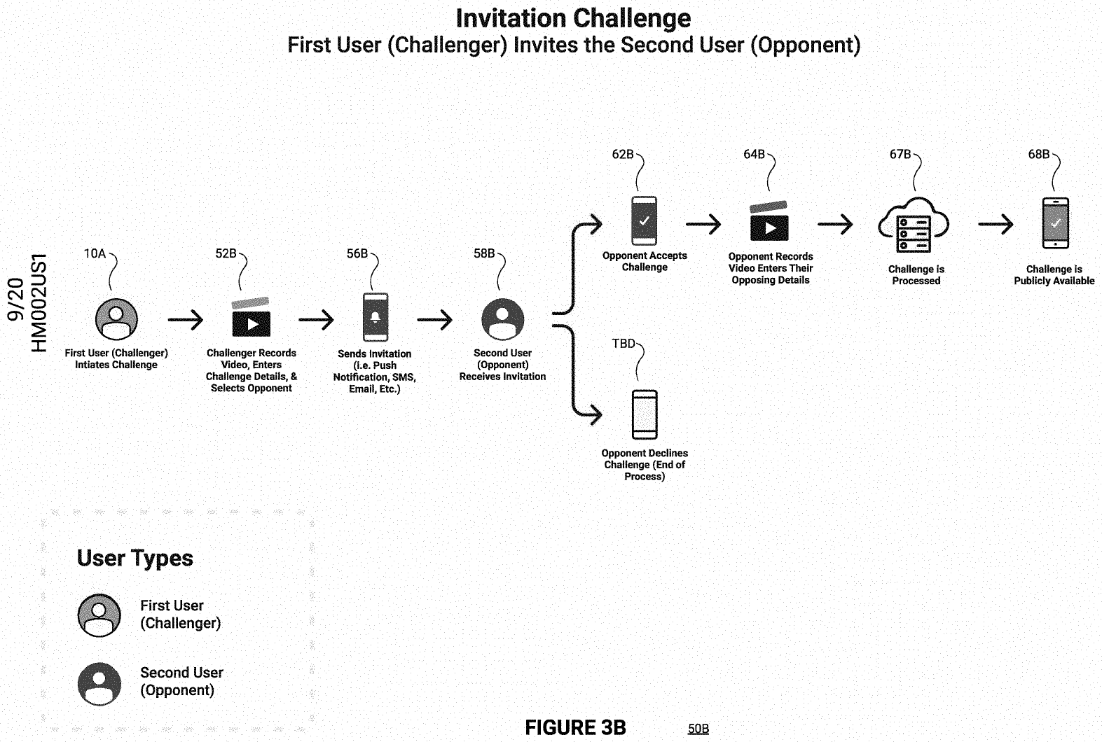

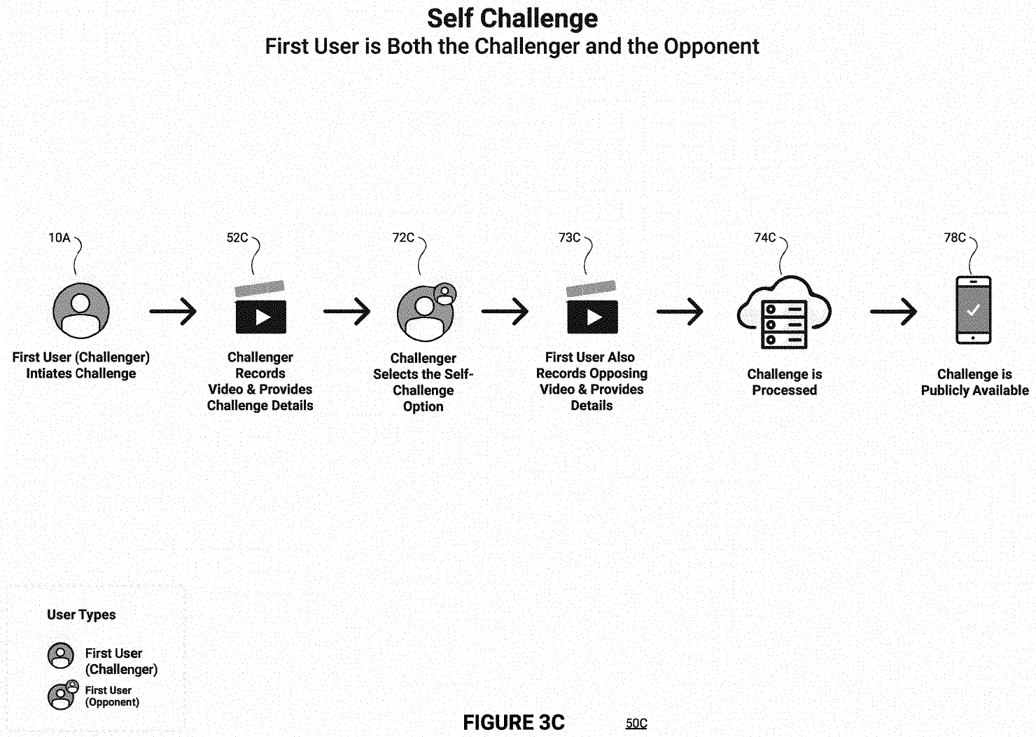

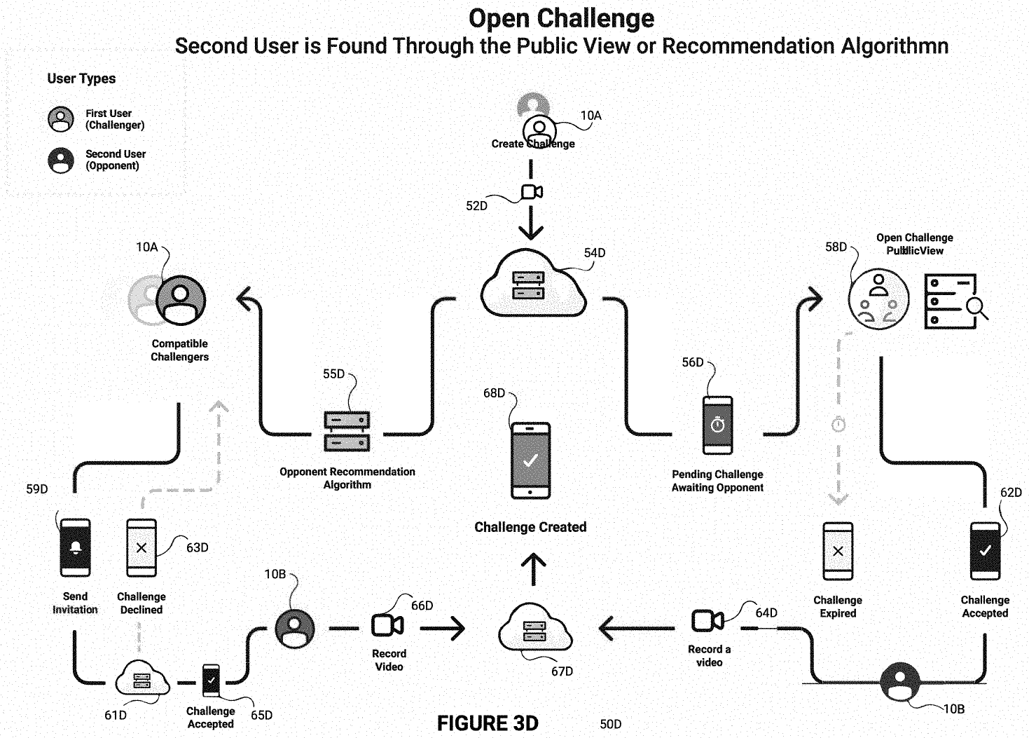

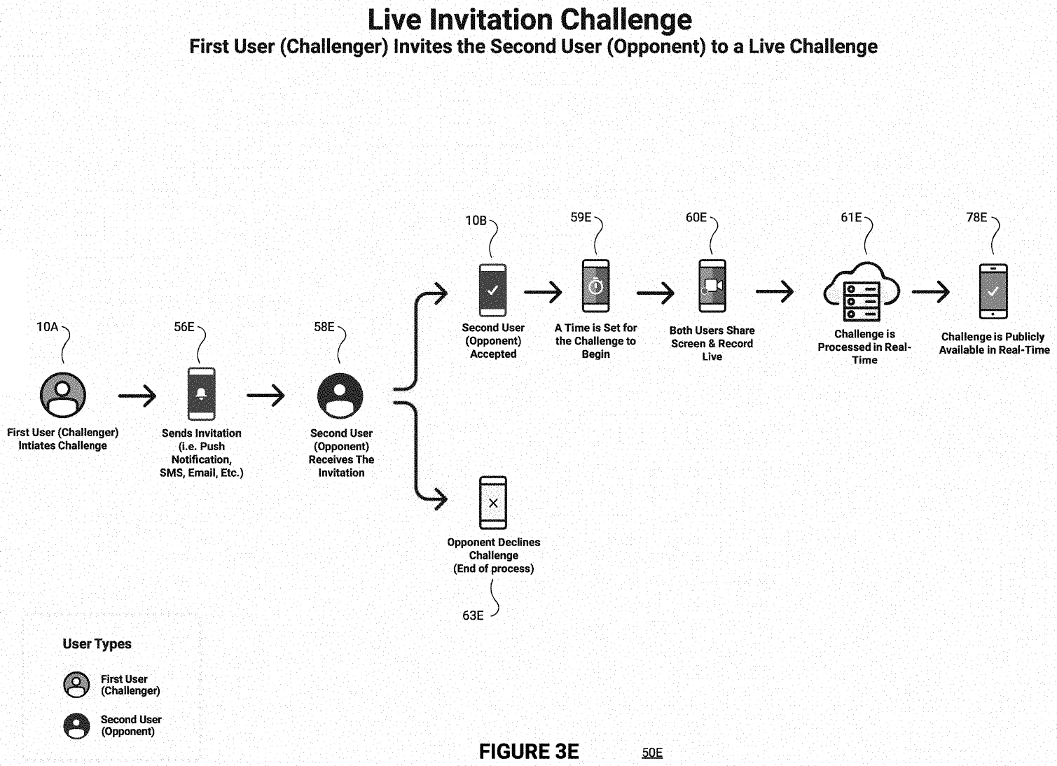

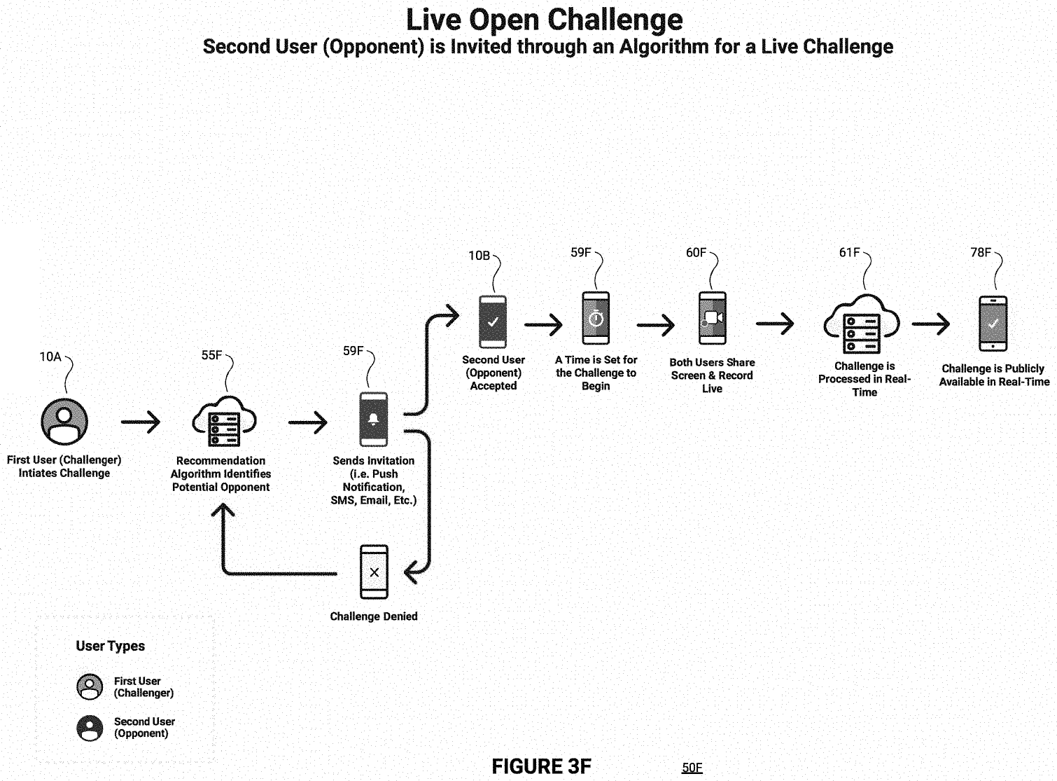

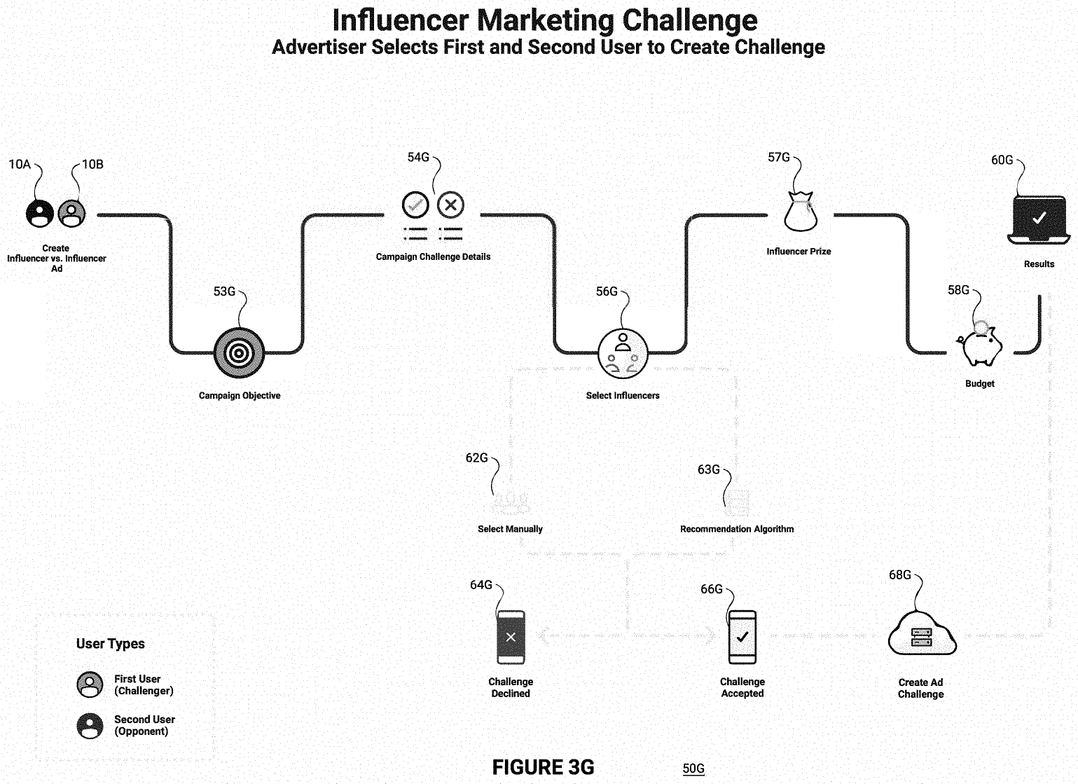

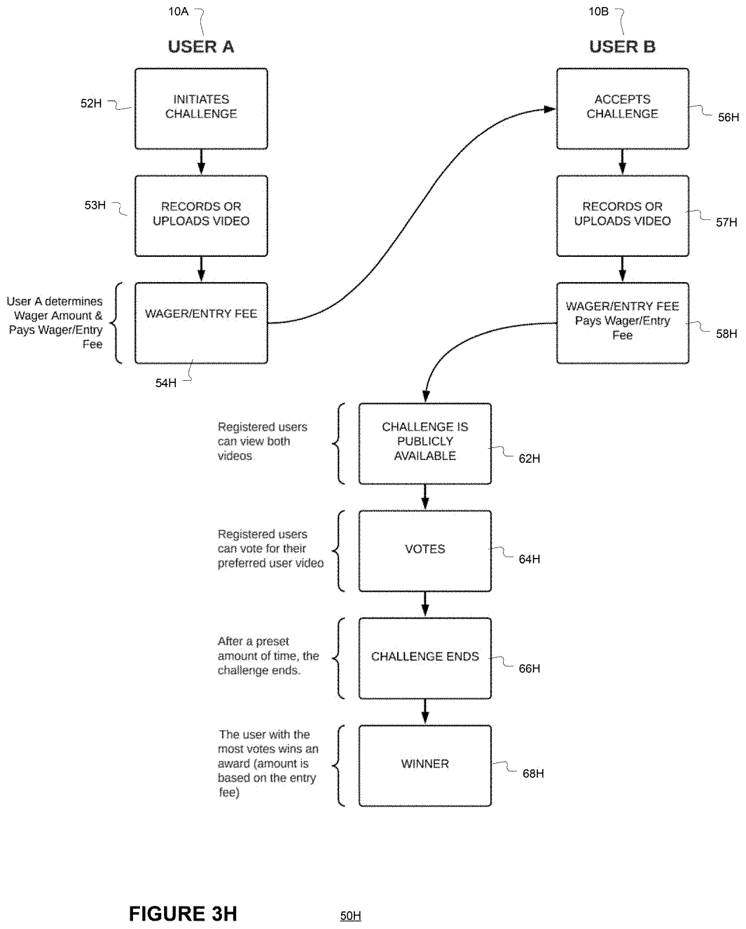

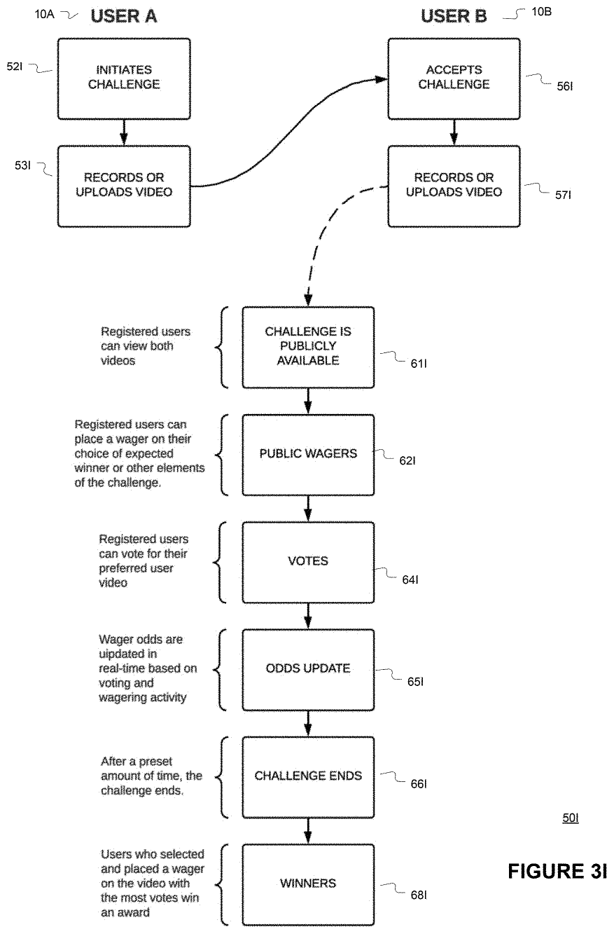

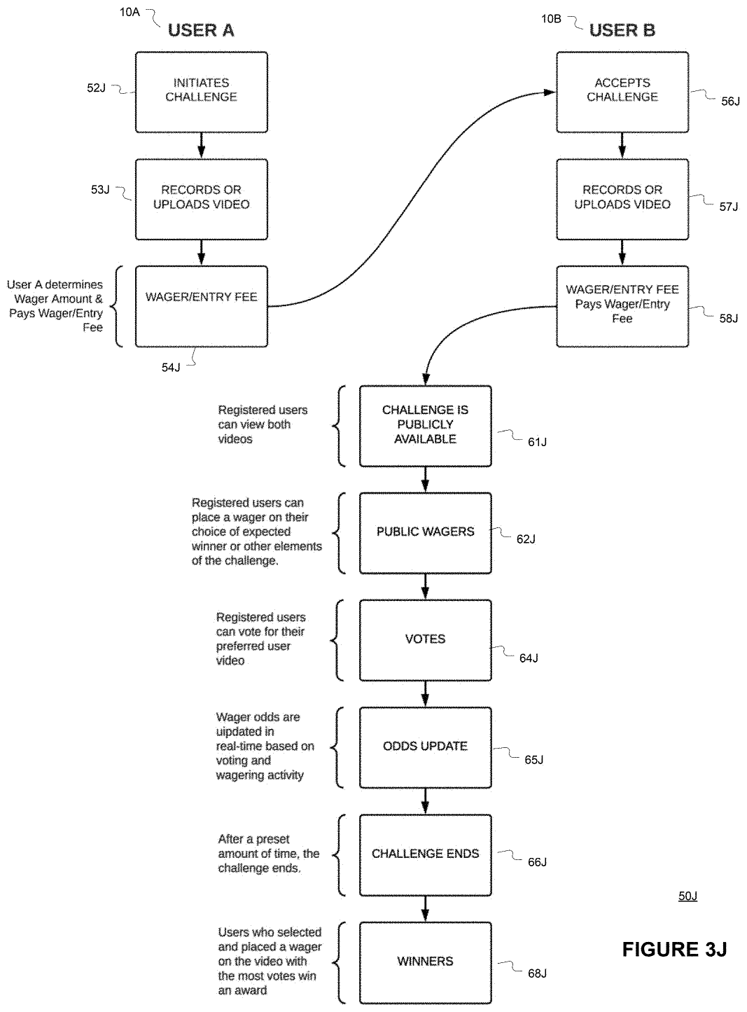

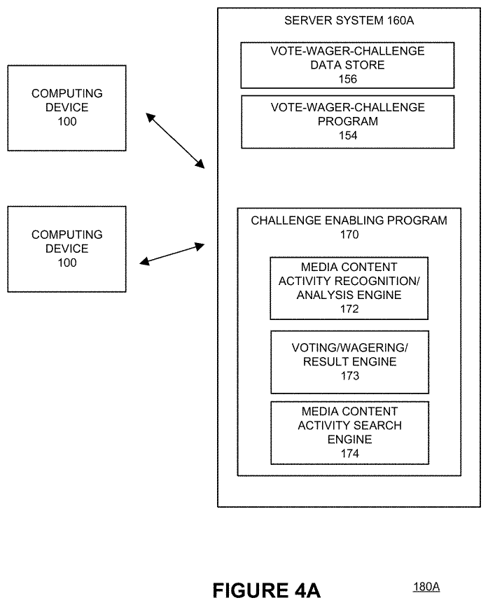

The vote/wagering/results engine 133 in conjunction with the challenge/voting/wagering enabling program 130 may also enable a User to vote and wagering on challenges between other Users as shown in FIGS. 2B, 2D, 2F and 2H and 3H-3J. In an embodiment, as shown in FIGS. 2B, 2D, 2F, and 2G, a non-competing User 10C may select to view the digital media content 202A, 202B of a User 10A-B by sliding/rotating 216I its content display tile or area 216A, 216B over the other content display tile or area 202B, 202A, 216A, 216B. A User 10C then may be able to vote for selected digital media content of a User 10A-B by depressing/toggling a vote tile or button 218F as shown in FIG. 2H, respectively. In other embodiments, a User 10C may vote for the digital media content tile or area 202A, 202B by selecting the vote tile or area of that content. Confirmation of the non-competing User's selection may be shown in an interface 200 as shown in FIGS. 2C (202A winner) and 2E (202B winner). As shown in FIGS. 2C and 2E, the selected digital media content 202A, 202B (winner) may be displayed along the current vote data 208 (for each contestant (challenger or opponent)).

As shown in FIGS. 2F and 2G, each digital media content 216A, 216B area 216L, 216M may be sized and segmented by a movable separator 216C via the digital media content activity search and vote/wagering/results engine 133 in conjunction with the challenge/voting/wagering enabling program 130. In an embodiment where the digital media content 216A, 216B includes a time variable component (such as video), digital media content 216A, 216B in each area 216L, 216M may vary in time continuously in a loop (from the beginning to end of the content in an embodiment). As a User 10A-C, selects content 216A, 216B by moving the separator 216C (sliding/rotating 216I in an embodiment), the area 216L of the selected content 216A may be enlarged as shown in FIG. 2G. As shown in FIG. 2H, a User 10C may be able to vote for a User's 10A-B digital media content 218C in a selected area 218L via a vote button/tile 218F of a voting interface 200. The voting interface 200 may also include the status of votes for the particular User's 10A-B digital media content 218A such as the percentage of votes received for their content. The voting interface 200 may also include title and hashtag information 218E for the selected User's 10A-B digital media content.

As also shown in FIGS. 2F and 2G, a User 10A-C may be able to navigate to different interfaces via buttons/tiles 216D, 216E, 216F, 216G, and 216H. In particular, a User 10A-C may be able to return to a starting interface 216D, search for content or particular challengers/opponents 216E, start a new challenge 216F such as via interface 200 shown in FIG. 1D, access a profile interface 216G such as shown in FIGS. 21 and 2J, and program settings 216H such as communication options, login profile, and other settings. As the User scrolls upward on the interface 200 shown in FIG. 2I, the user interface 126 in combination with the challenge/voting/wagering enabling program 130 may provide the changing interface 200 shown in FIG. 2J (showing more challenges 220J, 220K.)

As shown in FIGS. 21 and 2J, the profile interface 200 may provide several status/indicators/options 220B-220K including pending invitations 220B (to compete in challenges), activities of the User 220C, Users they are following 220D (in the system 160A, 160B), followers 220E (in the system 160A, 160B), the number of challenges lost in a certain time period 220F, the number of challenges won in a certain time period 220G, the percentage of times that the User 10A-C has voted for the ultimate winners of contests in a certain time period 220H, the total number of votes the User 10A-C has received or cast in a certain time period 220K, and displays of the User's 10A-C challenges 2201 for a certain time interval including past and active challenges 220J-K that the User 10A-C has/is participating in. It is noted that the certain time interval may be from for the User's 10A-C first use of the system 160A, 160B, reset periodically, or at the request of the User 10A-C. In an embodiment, a system 160A, 160B may award various forms or rewards/prizes or privileges to challengers, opponents, and viewers based on their performance and voting history (for example, a viewer part of the group electing a challenger winner).

In an embodiment, the invitations icon 220B may show challenge invitations the User 10A-C has pending (received but not accepted) and be selectable to provide an interface showing more details about pending invitations. As shown in FIGS. 21 and 2J, the challenges section 2201 may display images of the related digital media content of opponents for each challenge 220J and the images may change/vary with time where the corresponding digital media content also varies with time, such as video.

It should be understood that, for illustrative purposes, FIG. 1A does not show other computer systems and elements which may be present when implementing embodiments of the present invention. For example, in certain embodiments, digital media content activity capture/recognition engine 130 may communicate with one or more storage server computing devices (such as data storage & caching 154 or web storage 166B shown in FIG. 4B) to access user data store 122 in instances where user data store 122 is remotely hosted. Similarly, digital media content activity capture/recognition engine 132 may communicate with one or more server computing devices (160A, 160B—FIGS. 4A-B) via a network for additional computational power in instances where the computational power and resources of computing device 120 are limited.

FIGS. 4A and 4B are diagrams of architecture/environments 180A, 180B for implementing a digital-media based challenge and wagering system according to various embodiments. Computing environment 180A includes a server system 160A and two or more User 10A-C devices 120. The system 160A may include a vote-wager-challenge data store 156, a vote-wager-challenge program 154, and a challenge enabling program 170. The vote-wager-challenge program 154 may generate a graphical user interface (GUI) or a web user interface (WUI) and can display text, documents, web browser windows, user options, application interfaces 200, and instructions for operation, and includes the information (such as graphic, text, and sound) a program operating on a User device 120 presents to a user 10A-C and the control sequences the user 10A-C employs to control the program to vote for a competitor 202A-B and see vote results/data 206, compete in a challenge (FIGS. 1B-C and 2A-E), and wager on a challenge (FIGS. 1G and 3H-J).

The challenge enabling program 170 may include a digital media content activity recognition/analysis engine 172, a voting/wagering/result engine 173, and a digital media content activity search engine 174. Similar to engines 132 and 134, the digital media content activity recognition/analysis engine 172 and digital media content activity search engine 174 may include/employ a recognition algorithm to automatically detect the activity associated with an uploaded/provided User digital media content 202A-B. In an embodiment, a User 10A-C via options 204 may specify the activity or category of activity for their digital media content 202A-B. The digital media content activity search engine 174 may be employed to match Users for both challenges and voting options (to view challenges) based on User's 10A-C, past voting activities, past challenge, and past wagering activities. The voting/wagering/result engine 173 may provide/generate data for the Users device 120 voting/results engines 133 or work in combination or alone to engage a User 10C to view, vote, and wager on challenges between Users 10A-B or between a User 10A (self-challenge).

Computing environment 180B also includes a system 160B and two or more User 10A-C devices 120 along with systems 152-154, 162 that may enable scaling the environment 180B to handle many simultaneous challenges and votes by reducing the load on the system 160B. In particular, the notification services system 152 may provide real-time and batch notifications to Users 10A-C via their devices 120 regarding a challenge or voting opportunities. The notification services system 152 may control the operation of notification subsystem 164 in an embodiment.

The notification subsystem 164 may include a challenge management system 164A, messaging queue system 164B, and queue processor system 164C. The messaging queue 164B may store messaging requests generated by the system 160A and notification services system 152. The queue processor system 164C may process messages residing in the queue system 164B. The messages may present challenge, wagering, or voting opportunities or events. In an embodiment, when a challenge, wagering, or voting opportunity or event is available for a User, an application linked to such an opportunity or event may be forwarded to Users 10A-C device 120 via an application provider such as Firebase® 166A in an embodiment. The challenge management system 164A may work in conjunction with the notification system 152 and system 160A to match/couple competitors (Users 10A-C), wagering, and voting events.

As shown in FIG. 4B, the data storage and caching system 154 may be coupled to a database system 156 and an in-memory data store system 157. The data storage and caching system 154 may store User's 10A-C activities including voting, wagering, funds/points/tokens/charitable donations available for wagering, selected options 104, and provided digital media content 202A-B. The data storage and caching system 154 may store such activities in the database system 156 and in-memory data store system 157 in an embodiment. The in-memory data store system 157 may be employed in real-time data and have a faster data processing rate than the database system 156.

In an embodiment, the system 160A may be coupled to a plurality of servers 153 to enable many Users 10A-C to compete in challenges, wagering, and voting opportunities and events. The plurality of servers 153 may be coupled to the messaging system and a digital media content and User management processing system 164. The digital media content and User management processing system 162 may include a User management system or segment 162D, configurable settings 162A, analytics system 162B, digital media content upload service system 162C, upload queue system 162E, and digital media content compression and processing system 162F.

An administrator or certain Users 10A-C may be able to configure one or more operational settings 162A of a system 160A, 160B including the types of digital media content employed/accepted, User 10A-C management, voting management, wager management, and digital media content management. The analytics system 162B may provide challenge, wagering, voting, and User analytics, that may influence or be used to configure the settings system 162A in an embodiment. The User management system 162D may enable an administrator to control the privileges of Users 10A-C or may automatically modify User 10A-C privileges based on their activities in the system 160A, 160B. The uploaded digital media content system 162C may enable Users 10A-C via their device 120 to directly or indirectly (via a system 160A, 153), upload digital media content via an application 130 operating on their device 120.

The queue system 162E may store uploaded User's 10A-C uploaded digital media content prior to its compression and processing by the digital media content compression and processing system 162F. The digital media content compression and processing system 162F may standardize uploaded digital media content and reduce its storage size. The resultant standardized, compressed, digital media content may be stored in one or more cloud storage systems. The digital media content compression and processing system 162F may also generate compressed versions of the Users, 10A-C to formats usable by different devices 120 and application 120 interfaces 200.

FIGS. 3A-J are diagrams of digital-media based challenge and wagering system dataflows 50A-F according to various embodiments. As shown in FIG. 3B, a User 10A via their device 120 may generate digital media content including an activity that includes a challenge to other User(s). In an embodiment, the User's 10A device 120 may have a camera and be capable of generating/recording digital media content including digital video clips. To create a challenge, a User 10A via their device 120 may use a webpage or application operating on their device to record and upload digital media content (activity 52B) to a system 160A. In an embodiment, a User 10A may be required to use a webpage associated with the system 160A, 160B or application provided by system 160A, 160B to both record and upload digital media content to ensure the integrity of the resultant digital media content.

The User's 10A digital media content may be compressed via system 162F and stored in a cloud storage system 166B for further data integrity and reduce bandwidth requirements to communicate the digital media content to other Users 10B-C via their devices 120. In an embodiment, a User 10A may specify a particular User that they want or are willing to challenge (activity 56B). In such an embodiment, computer system/environment 160A, 160B may send a challenge request (activity 58B) to the particular User via an application or webpage on such a particular User's device 120. The notification services system 152, messaging queue 164B, queue processor 164C, and application delivery system 166A may be employed to forward a challenge request to a User 10B-C that is not registered in the system 160A (in system 162D) or does not have the challenge application installed on their device 120.

Otherwise, the User to be challenged may be notified with the challenge application on their device 120 (activity 58B) or other messaging providers including short messaging service (SMS), Imessaging®, Email, or other messaging service or application via the Internet (network of networks), any local network or communication protocol or system (including Bluetooth, Bluetooth beacons, air tags, ultra-wide band, WiFi, mesh, and others), cellular network, or satellite network(s). In another embodiment, a User 10A may enable the system 160A, 106B to locate/select another User 10B-C to participate in a challenge (activities 55D, 59D) as demonstrated in FIG. 3D. The system 160A in combination with the challenge management 164A, analytics 162B, and user management 162D, may analyze the User's 10A digital media content, other User's 10B-C past challenges, their interests, and past interactions to determine one or more compatible or desirable challengers 10B where the list may be sorted based on such factors.

A compatible challenger may be notified (sent invitation—activity 59D) with the challenge application on their device 120 (activity 58D) or other messaging providers including short messaging service (SMS), Imessaging®, Email, or other messaging service or application via the Internet (network of networks), cellular network, or satellite network(s). If the challenge is declined (activity 63D), the next compatible challengers 10B may be notified (activity 59D and 61D) until a challenge is accepted (activity 65D).

Then in either flow, after a challenge is accepted (activity 62D, 65D), the challenger (User 10B) may generate/document their activity/response to the other User 10A digital media content via their device 120 (activities 64D, 66D) where their resultant digital media content may be stored in a server or cloud (activity 67B, 67D) to form a completed challenge (activity 68B. 68D)—FIG. 2A—display—200—enabling another User 10C to view each Users' compilation reflected by their digital media content 202A, 202B.

FIGS. 3B-F are diagrams of digital-media based challenge dataflows 50B-F according to various potential embodiments. Dataflow 50A demonstrates a number of challenge formats which user 10A may initiate, with diagrams 50B-F detailing their various embodiments: a. selected opponent/User 10B-C (50B); b. against themselves (50C); or c. via a system 160A generated/determined opponent/User 10B-C (50D). In each scenario, an opponent/User 10B-C generates their submission/activity/response to the challenge via their device 120 (activities 64B, 73C, 64D, 66D) as part of the process to complete the challenge (activity 68B, 78C, 68D). In the scenario where a User 10A competes against himself, another User 10C may be voting on which submission/activity/response 202A, 202B they preferred/prefer.

FIG. 3G is another diagram of a digital-media based challenge data flow 50G according to various embodiments. In data flow 50G, an advertising campaign may be established based on a challenge between well-known Users 10A-B. In an embodiment the well-known Users 10A-B may be social media celebrities or influencers. In an embodiment, campaign objectives (activity 53G) may be determined, such as the market/people/Users to be targeted to view the resultant challenges. The timing and details of the campaign/challenge(s) may also be determined (activity 54G) including the types/categories of submission/activity/response 202A, 202B for the selected Users 10A, 10B to perform for the challenge(s). Then Users 10A, 10B to compete in the challenges of the campaign may be selected manually (activity 62G) or via a recommendation algorithm (activity 63G).

The recommendation algorithm may select two or more Users 10A-C to compete based on the category of the advertisement in an embodiment. For example, for a golf equipment company, the algorithm 63G may target social media influencers known for their golf-related skills. Similar to other dataflows 50B-F, the respective selected/elected Users 10A-B may be notified of the proposed challenge(s) and be able to accept (activity 66G) or decline the challenge(s) (activity 64G). The selected Users 10A-B may be informed of a potential prize/reward(s) including cash for the challenge(s) (activity 57G). It is noted that a campaign may comprise many challenges between many Users 10A-B leading to a final challenge between the group of Users 10A-B. Based on the selected prize(s) (activity 57G), a budget may be finalized (activity 58G) and the Ad challenge created (activity 68G). Users 10A-C may vote on the challenge(s) as they progress to the resultant winner(s) (activity 60G).

FIGS. 3H-J are diagrams of a digital-media based challenges with wagering data flows 50H-J according to various embodiments. In data flow 50G, two Users 10A, 10B place wagers for a competition between themselves where other users vote for the challenge winner. In data flow 50I, other users wager and/or vote for one or more Users 10A-C participating in a challenge. In data flow 50J, both the challengers (Users 10A, 10B) and other users may wager on a challenge between the Users 10A, 10B.

As shown in FIG. 3H, a User 10A may initiate a challenger 52H as described herein by uploading or recording digital media 53H. The User 10A (before or after uploading or recording digital media) may set or accept a wager or entry fee (funds/points/tokens/charitable donations) for the challenge 54H. In an embodiment, a User 10A may set the wager amount or range for a challenge. The wager amount or range that a User 10A may select may be based on their past activities in the system 160A, 160B. In an embodiment, the system 160A, 160B (such as via challenge management 164A) may set the wager or entry fee or amount, where the amount may be based on the User 10A or the challenge media (after being analyzed in an embodiment).

Similarly, a User 10B may be notified of the challenge (as described above) 50H and then record or upload digital media 57H and select or accept a wager or entry fee/amount 58H. As noted, the order of activities 57H, 58H may vary. The wager or entry fee/amount for User 10B may be set similar to a User 10A (where a User 10B may determine or the system 180A, 180B may determine). In addition, the wager/entry fee or amount may not be required to be equal between challengers 10A, 10B. Then similar to flows 50A-50F, other users may be able to view the challenge 62H, votes for one or more Users 10A-C associated with a challenge 66H (where the Users may be associated or registered with the system 160A, 160B).

Then funds/points/tokens/charitable donations distribution between Users 10A, 10B may be determined based on the timed vote of other Users (the determined winner(s)) 66H, 68H.

In FIG. 3I, data flow 50I enables other Users (not part of a challenge) to wager on a challenge created between users (52I, 53I, 56I, and 57I) once the challenge is published 61I and the other Users are permitted to view the challenge (the challenge could be public or limited to particular other Users in an embodiment). Then the other Users 10C may be able to wager funds/points/tokens/charitable donations on the challenge 64I. The amount of the wager funds/points/tokens/charitable donations that a particular User 10C may be able to enter may be limited by the system 160A, 160B or Users 10A, 10B in an embodiment. Wagering Users 10C may also vote on the challenge 64I. In an embodiment, a User 10C may only be able to wager on a challenge after voting on the challenge. In other embodiments, a wagering User 10C may not be required to vote on a challenge.

Based on the wagering for the challengers 10A, 10B by other Users 10C, the system 160A, 160B may provide varying odds (variable winnings for wages) to ensure that more winning amounts are not paid than wager amounts in an embodiment 65I. Once the challenge ends 66I (times out in an embodiment), the system 160A, 160B may determine the challenge winner 68I and payouts (winning amounts) for each wager placed by other Users 10C. The system 160A, 160B may update points/token/funds of wagering Users 10A-C based on their winnings or losses.

As shown data flow 50J in FIG. 3J, in an embodiment both challengers 10A, 10B, and other Users 10C may be able to place wagers 54J, 58J, 62J on a challenge 52J, 53J, 56J, 57J between Users 10A, 10B. The odds determination 65J may account for the wager(s) of the challengers 10A, 10B, and other Users 10C in an embodiment.

FIG. 5 depicts a block diagram of components of computing device 300 that may be employed as a computer device 120 or system 160A, 160B or other system shown in FIGS. 4A and 4B, in accordance with an illustrative embodiment of the present invention. It should be appreciated that FIG. 5 provides only an illustration of one implementation and does not imply any limitations with regard to the environments in which different embodiments may be implemented. Many modifications to the depicted environment may be made.

Computing device 300 may include a communications bus 302, which provides communications between computer processor(s) 304, memory 306, persistent or non-volatile storage 308, communications module 310, and input/output (I/O) interface(s) 312. Communications bus 302 can be implemented with any architecture designed for passing data and/or control information between processors (such as microprocessors, communications and network processors, etc.), system memory, peripheral devices, and any other hardware components within a system. For example, communications fabric 302 can be implemented with one or more buses.

Memory 306 and storage 308 may be computer readable storage media. In this embodiment, memory 306 may include random access memory (RAM) 314 and cache memory 316. In an embodiment, memory 306 may include any suitable volatile or non-volatile computer readable storage media.

In an embodiment, User program 124, user data store 122, digital media content activity capture/recognition engine 132, media content activity search 134 and vote/wagering/results engine 133, challenge/voting/wagering enabling program 130, vote-wager-challenge data store 156, vote-wager-challenge program 154, challenge enabling program 170, media content activity recognition/analysis engine 172, and media content activity search 174 and voting/wagering/result engine 173 may be stored in storage 308 for execution and/or access by one or more of the respective computer processors 304 via one or more memories of memory 306. In an embodiment, storage 308 may include a magnetic hard disk drive or a solid-state drive, a semiconductor storage device, read-only memory (ROM), erasable programmable read-only memory (EPROM), flash memory, or any other computer readable storage media that is capable of storing program instructions or digital information.

In an embodiment, media used by storage 308 may also be removable. For example, a removable hard drive may be used for storage 308. Other examples include optical and magnetic disks, thumb drives, and smart cards that are inserted into a drive for transfer onto another computer readable storage medium that is also part of storage 308.

Communications module 310 may provide communications with other data processing systems or devices, including computing device 120, system 160A, 160B, and other systems shown in FIGS. 4A and 4B. In an embodiment, communications module 310 may include one or more network interface cards including cellular or satellite interfaces. Communications module 310 may provide communications through the use of either or both physical and wireless communications links. User program 124, user data store 122, digital media content activity capture/recognition engine 132, media content activity search 134 and vote/wagering/results engine 133, challenge/voting/wagering enabling program 130, vote-wager-challenge data store 156, vote-wager-challenge program 154, challenge enabling program 170, media content activity recognition/analysis engine 172, and media content activity search 174 and voting/wagering/result engine 173 may be downloaded to storage 308 through communications module 310.

I/O interface(s) 312 may allow for input and output of data with other devices that may be connected to or part of the computing device 300. For example, I/O interface 312 may provide a connection to an input device such as a keyboard, keypad, touch screen, video camera/lens, and/or some other suitable input device. Input devices 318 can also include portable computer readable storage media such as, for example, thumb drives, portable optical or magnetic disks, and memory cards. Software and data used to practice embodiments of the present invention, e.g., User program 124, user data store 122, digital media content activity capture/recognition engine 132, media content activity search 134 and vote/wagering/results engine 133, challenge/voting/wagering enabling program 130, vote-wager-challenge data store 156, vote-wager-challenge program 154, challenge enabling program 170, media content activity recognition/analysis engine 172, and media content activity search 174 and voting/wagering/result engine 173 may be stored on such portable computer readable storage media and can be loaded onto storage 308 via I/O interface(s) 312. I/O interface(s) 312 may also connect to a display or user perceptive module 320 in an embodiment.

The user perceptible module 320 may provide a mechanism to communicate data to a user and may be, for example, a computer monitor or an incorporated display screen, such as is used in tablet computers and smartphones, audio speaker, heads up display (HUD), virtual reality system, or other user perceptible mechanism capable of communicating data.

The programs described herein are identified based upon the application for which they are implemented in a specific embodiment of the invention. However, it should be appreciated that any particular program nomenclature herein is used merely for convenience and thus, the invention should not be limited to use solely in any specific application identified and/or implied by such nomenclature.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network (LAN), a wide area network (WAN), and/or a wireless network. The network may comprise copper transmission cables, optical transmission fibers, wireless transmission, routers, firewalls, switches, gateway computers, and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flow illustrations and/or block diagrams of methods, apparatus (systems), and computer program products according to embodiments of the invention. It will be understood that each block of the flowchart illustrations and/or block diagrams, and combinations of blocks in the flow illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flow diagrams and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flow diagram and/or block diagram block or blocks.

The computer readable program instructions may also be loaded onto a computer, other programmable data processing apparatus, or other device to cause a series of operational steps to be performed on the computer, other programmable apparatus, or other device to produce a computer implemented process, such that the instructions which execute on the computer, other programmable apparatus, or other device implement the functions/acts specified in the flow diagrams and/or block diagram block or blocks.

The data flows or flow diagrams and block diagrams in the figures illustrate the architecture, functionality, and operation of possible implementations of systems, methods, and computer program products according to various embodiments of the present invention. In this regard, each block in the flowchart or flow diagrams, or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The Abstract of the Disclosure is provided to comply with 37 C.F.R. § 1.72(b), requiring an abstract that will allow the reader to quickly ascertain the nature of the technical disclosure. It is submitted with the understanding that it will not be used to interpret or limit the scope or meaning of the claims. In the foregoing Detailed Description, various features are grouped together in a single embodiment for the purpose of streamlining the disclosure. This method of disclosure is not to be interpreted to require more features than are expressly recited in each claim. Rather, inventive subject matter may be found in less than all features of a single disclosed embodiment. Thus, the following claims are hereby incorporated into the Detailed Description, with each claim standing on its own as a separate embodiment.

What is claimed is:

1. A method comprising:
receiving, by one or more processors, first digital media content from a First User's computing device, wherein the first digital media content comprises data representative of a first activity;
receiving, by one or more processors, a first wager from the First User's computing device;
receiving, by one or more processors, second digital media content from a Second User's computing device, wherein the second digital media content comprises data representative of a second activity;
receiving, by one or more processors, a second wager from the Second User's computing device;
sending, by one or more processors, to a Third User's computer device data enabling the Third User's computer device to display an interface including at least portions of the first digital media content and the second digital media content and enabling the Third User via their computer device to select one of the first digital media content and the second digital media content;
receiving, by one or more processors, the selection of the Third User from the Third User's computing device;
providing an award to one of the First User and the Second User based on the selection of the Third User.

2. The computer-implemented method of claim 1, wherein the award provided to one of the First User and the Second User based on the selection of the Third User is based on the first wager and second wager.

3. The computer-implemented method of claim 1, wherein the first wager is equal to the second wager.

4. The computer-implemented method of claim 1, wherein the first activity is one of performed, provided, and created by the First User and the second activity is one of performed, provided, and created by the Second User.

5. The computer-implemented method of claim 4, comprising receiving, by one or more processors, first digital media content from a digital media content providing device of the First User's computing device and receiving, by one or more processors, second digital media content from a digital media content providing device of the Second User's computing device.

6. The computer-implemented method of claim 1, comprising enabling the Third User's computer device to display an interface including at least portions of the first digital media content and the second digital media content simultaneously.

7. The computer-implemented method of claim 1, further comprising receiving, by one or more processors, a third wager from the Third User's computing device.

8. The computer-implemented method of claim 7, further comprising receiving, by one or more processors, a fourth wager from a Fourth User's computing device.

9. The computer-implemented method of claim 1, further comprising:
sending, by one or more processors, to a plurality of other Users' computer devices data enabling the plurality of other Users' computer devices to display an interface including at least portions of the first digital media content and the second digital media content and enabling the plurality of other Users via their computer device to select one of the first digital media content and the second digital media content; and
comprising providing an award to one of the First User and the Second User based on the selections of the plurality of other Users.

10. The computer-implemented method of claim 8, further comprising:
sending, by one or more processors, to a plurality of other Users' computer devices data enabling the plurality of other Users' computer devices to display an interface including at least portions of the first digital media content and the second digital media content and enabling the plurality of other Users via their computer device to select one of the first digital media content and the second digital media content; and
comprising providing an award to one of the First User and the Second User based on the selections of the plurality of other Users and providing awards to the Third User and the Fourth User based on the selections of the plurality of other Users.

11. A method comprising:
receiving, by one or more processors, first digital media content from a First User's computing device, wherein the first digital media content comprises data representative of a first activity;
receiving, by one or more processors, second digital media content from a Second User's computing device, wherein the second digital media content comprises data representative of a second activity;
sending, by one or more processors, to a plurality of other Users' computer devices data enabling the plurality of other Users' computer devices to display an interface including at least portions of the first digital media content and the second digital media content and enabling the plurality of other Users via their computer device to select one of the first digital media content and the second digital media content;
receiving, by one or more processors, a wager from a Third User's computing device
receiving, by one or more processors, selections of one or more of the plurality of other Users from the plurality of other Users' computer devices;
providing an award to the Third User based on the received selections of the plurality of other Users.

12. The computer-implemented method of claim 11, wherein the award provided to the Third User is based on the Third User's wager.

13. The computer-implemented method of claim 11, wherein the first activity is one of performed, provided, and created by the First User and the second activity is one of performed, provided, and created by the Second User.

14. The computer-implemented method of claim 13, comprising receiving, by one or more processors, first digital media content from a digital media content providing device of the First User's computing device and receiving, by one or more processors, second digital media content from a digital media content providing device of the Second User's computing device.

15. The computer-implemented method of claim 11, comprising enabling each of the plurality of other Users' computer devices to display an interface including at least portions of the first digital media content and the second digital media content simultaneously.

16. The computer-implemented method of claim 11, wherein the Third User is one of the plurality of other Users.

17. The computer-implemented method of claim 11, further comprising receiving, by one or more processors, a wager from a Fourth User's computing device.

18. The computer-implemented method of claim 17, further providing awards to the Third User and the Fourth User based on the received selections of the plurality of other Users.

19. The computer-implemented method of claim 17, further providing awards to the Third User and the Fourth User based on the received selections of the plurality of other Users and the Third User wager and the Fourth User wager.

20. The computer-implemented method of claim 18, wherein the Third User is one of the plurality of other Users and the Fourth User is one of the plurality of other Users.
